(19) United States
(12) Patent Application Publication
(10) Pub. No.: US 2026/0224924 A1
(43) Pub. Date: Aug. 6, 2026

(54) WIRE BRUSH ASSEMBLY AND METHOD OF REPLACING WIRE BRUSH FROM SELF RETRACTING LIFELINE

(71) Applicant: PN INTERNATIONAL PRIVATE LIMITED, Uttar Pradesh (IN)

(72) Inventor: Rajesh NIGAM, Uttar Pradesh (IN)

(21) Appl. No.: 19/149,822

(22) PCT Filed: Jan. 24, 2024
(86) PCT No.: PCT/IN2024/050069

§ 371 Date: Jul. 21, 2025

(30) Foreign Application Priority Data
Jan. 25, 2023 (IN) 202311005149

(51) Int. Cl. A62B 35/00

(52) U.S. Cl. CPC A62B 35/0093

(57) ABSTRACT

The present invention relates to a wire brush assembly and method of replacing wire brush form Self Retracting Lifeline (SRL) includes an outer guide and an inner guide. The outer guide is fixed with a housing of the SRL. The outer guide and inner guide have matching holes to align the guides with each other via attachment means. The inner guide designed to insert/extract from the outer guide by push fit or threaded profile. The inner guide has a sunk profile with a collar on its periphery to accommodate a wire brush between a cavity in the outer and inner guide. Further both the guides are secured together with help of the attachment means after replacement of the wire brush in the assembly.

### FIELD OF INVENTION

The present invention relates to the field of self retracting lifelines. The present invention particularly relates to, a wire brush assembly and method of replacing wire brush from self retracting lifeline.

### BACKGROUND OF THE INVENTION

Self-retracting lifelines (SRLs) are well known and often used in fall protection safety equipment for use by workers performing tasks during which there is a risk a fall may occur. There are many types and sizes of rotary wire brushes used in various types of abrasive removal and surface finishing applications. Wire brushes are incorporated in the lifeline of SRLs to prevent dust and dirt which accompanies the wire rope, while being retracted inside the housing, scales on the moving parts which may directly affect the primary functionality of the product.

Typically after number of retraction and extraction of the wire rope while in usage, wire brush gets distorted and needs to be replaced. As of now in order to replace the wire brush, entire wire brush unit needs to be removed from service and sent to authorized personnel to open the whole wire brush unit and replace the wire brush and then assemble it back. Hence it's a complex and tedious process of changing wire brush because different SRLs have wire brush units installed within their housing.

There are several patent application that provides different types of wire brush assembly or holder in self retracting lifelines. One such Patent Application U.S. Pat. No. 7,281,620B2 discloses a self-retracting lifeline that includes a centrifugal clutch assembly having a pawl and a spring. The pawl and the spring, which do not require any fixed attachment to any other component of the device, are held in place and pivotable within a plate. The plate is rotatable within a cavity of a brake hub including teeth extending into the cavity. When a centrifugal force is applied, the pawl compresses the spring and moves away from the plate to engage the teeth thereby activating a brake assembly within the self-retracting lifeline. The aforementioned prior art discloses about a centrifugal clutch assembly of self-retractable lifelines, hence the prior art lacks to disclose easy method of changing the wire brush at the orifice of the SRL without the need of opening the complete unit.

KR101463772B1 discloses a wire brush holder. a brush holder for a wire brush which is mounted and rotated on a brush holder fixing device and is used to peel paint or a rubber liner which is strongly adhered or coated on the internal surface of a cylinder. The brush holder for a wire brush comprises: a cylindrical body which has a hollow unit in order to be mounted on a brush holder fixing device; multiple brush holes which are formed at particular intervals in a length direction on the outer circumference of the body; a brush unit which has a bottom inserted in the brush hole and a top protruding to the outside of the brush hole; a bolt settling groove which is formed to adjacently correspond to each of the brush holes on the outer circumference of the body; multiple bolt holes which are formed in the bolt settling groove and are connected with each of the brush holes; a pressing bolt which presses the brush unit in order not to separated from the brush hole when the press bolt is coupled with the bolt hole and is rotated in a clockwise direction and forwardly moved, and loosens the pressed and fixed brush unit when the pressing bolt is rotated in a counterclockwise direction and is backwardly moved, wherein the protruding length of the brush unit is adjusted or the brush unit can be replaced. The aforementioned prior art talks about buffing machine type holders with rotating brushes to peel out paint and rubber lining from the surface. Therefore the prior art lacks to disclose method or assembly that ease of changing of wire brush.

CN202144585U discloses a wire brush quick-change assembly for a dirt brusher capable of clearing away dirt for a safety barrier baffle plate. The wire brush quick-change assembly for a dirt brusher, via structure improvement, makes the wire brush be quickly and conveniently changed by manual work when the brush wire is worn due to long-time use of the dirt brusher; via split design of a transmission shaft and a wire brush driving shaft, and disposing of a supporting plate between the transmission shaft and the wire brush driving shaft to perform isolation, a transmission mechanism in the brusher and a brushing working zone are effectively isolated, thereby guaranteeing long-term stability and reliability of whole machine performance, and effectively reducing dust pollution generated in brushing process. The aforementioned prior art discloses a stationary type dirt brushed used for cleaning shoes in office. Hence lacks to provide any suitable solution to ease change of wire brush in the self retracting lifeline.

In view of the above problems associated with the state of the art, there is a need of a solution where one can replace the wire brush (which is a frequent exercise) on site without the need of opening the whole unit of self retracting lifeline which provide compact structure and have low-cost of manufacturing.

### OBJECTIVES OF THE INVENTION

The primary objective of the present invention is to provide a wire brush assembly to ease wire brush changing process in Self Retracting Lifelines (SRLs) or fall arrestors.

Another objective of the present invention is to provide compact, less complex and easy to use wire brush assembly.

Yet another objective of the present invention is to reduce cost of manufacturing of a wire brush assembly for the SRLs or fall arrestors.

Other objects and advantages of the present invention will become apparent from the following description taken in connection with the accompanying drawings, wherein, by way of illustration and example, the aspects of the present invention are disclosed.

### BRIEF DESCRIPTION OF DRAWINGS

The present invention will be better understood after reading the following detailed description of the presently preferred aspects thereof with reference to the appended drawings, in which the features, other aspects and advantages of certain exemplary embodiments of the invention will be more apparent from the accompanying drawing in which:

FIG. 1 illustrates an exploded view of a wire brush assembly.

### SUMMARY OF THE INVENTION

The present invention relates to a wire brush assembly and method for replacing wire brush from self retracting lifeline. The assembly includes an outer guide which is fixed with the housing of a Self Retracting Lifeline (SRL). The outer guide and inner guide have matching holes which are used to align and secure both the guides by attachment means. The inner guide is inserted inside the outer guide by push fit or threaded profile. The inner guide has a sunk profile with collar on its periphery to accommodate number of wire brush between the outer guide and sunk profile of the inner guide. Collared profile of the inner guide touches the outer guide inner wall and creates adequate gap to secure one wire brush in its position. Once the wire brush is placed inside cavity, both the guides are screwed/riveted or fastened together with help of dowels or other attachment means.

### DETAILED DESCRIPTION OF THE INVENTION

The following description describes various features and functions of the disclosed system with reference to the accompanying figures. In the figures, similar symbols identify similar components, unless context dictates otherwise. The illustrative aspects described herein are not meant to be limiting. It may be readily understood that certain aspects of the disclosed system can be arranged and combined in a wide variety of different configurations, all of which have not been contemplated herein.

Accordingly, those of ordinary skill in the art will recognize that various changes and modifications of the embodiments described herein can be made without departing from the scope of invention. In addition, descriptions of well-known functions and constructions are omitted for clarity and conciseness.

Features that are described and/or illustrated with respect to one embodiment may be used in the same way or in a similar way in one or more other embodiments and/or in combination with or instead of the features of the other embodiments.

The terms and words used in the following description are not limited to the bibliographical meanings, but, are merely used to enable a clear and consistent understanding of the invention. Accordingly, it should be apparent to those skilled in the art that the following description of exemplary embodiments of the present invention are provided for illustrative purpose only and not for the purpose of limiting the invention.

It is to be understood that the singular forms “a”, “an” and “the” include plural referents unless the context clearly dictates otherwise.

It should be emphasized that the term “comprises/comprising” when used in this specification is taken to specify the presence of stated features, integers, steps or components but does not preclude the presence or addition of one or more other features, steps, components or groups thereof. The equations used in the specification are only for computation purpose.

The present invention relates to a wire brush assembly and method of replacing wire brush from self retracting lifeline. The wire brush assembly provide a simple solution to change old wire brush and replace with new one in Self Retracting Lifelines.

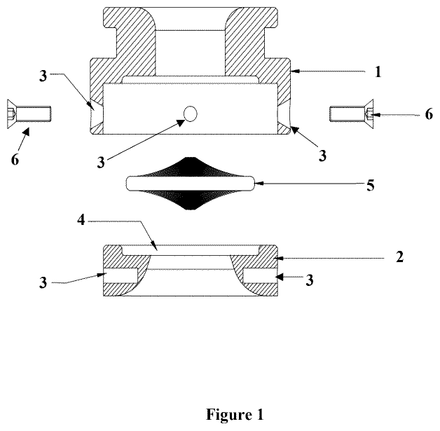

FIG. 1 illustrates, an exploded view of a wire brush assembly. The assembly includes an outer guide (1) and an inner guide (2). In a preferred embodiment, the assembly is made of two main parts i.e. outer guide (1) (shown in FIG. 1) and inner guide (2) (shown in FIG. 1). The inner guide (2) and outer guide (1) are made of materials that are selected from but not limited to, steel, aluminum, iron and its standard and customized grades, polymers and its standard and customized grades with or without reinforcements or any other combination thereof.

In a preferred embodiment, the outer guide (1) may have a round profile or A/F profile as outer structure and the outer guide (1) have inner profile as inner structure. The outer guide (1) is fixed or assembled a main housing or casing of Self Retracting Lifeline (SRL) or retractable fall arrester block by attachment means (6). The outer guide (1) has minimum one groove profile to seat the SRL housing covers. The attachment means (6) include but not limited to, screws, rivets, and clamps. It is to be noted that, the outer guide (1) remains permanently fixed with the SRL housing.

In an embodiment, the outer guide (1) has one or more matching holes (3) or tapping profiles formed on its periphery. The holes (3) are formed in a way such that the holes (3) able to allow insertion or removal of screws or other attachment means (6) through the holes (3). In an exemplary embodiment, the outer guide (1) has four holes (3) formed on its periphery.

In an embodiment, the inner guide (2) is preferably having a hollow circular shape. The inner guide (2) is structured to be inserted inside the outer guide (1) by a push fit (i.e. by inner guide (2) slides inside the outer profile if pushing force applied over the inner guide) or threaded profile. In an exemplary embodiment, the inner guide (2) having four holes (3) on its periphery. The inner guide (2) slides in the outer guide (1) and touches the inner wall of outer guide (1) for final position. In a preferred embodiment, the inner guide (2) slides in the outer guide (1) and touches the inner wall of the outer guide (1) for final position. In a preferred embodiment, the inner guide (2) having a collar profile and the collar profile of the inner guide (2) touches the outer guide (1) inner wall and creates adequate gap to secure one wire brush (5) in its position.

The inner guide (2) has a sunk profile (4) with the collar on periphery just to accommodate one or more wire brush(s) between the outer guide (1) and sunk profile (4) of the inner guide (2). It is to be noted that sunk profile (4) is structured to fit one wire brush (5) between the inner and outer guide (1, 2). The sunk profile (4) is structured in a way such that the sunk profile (4) holds the wire brush (5) in its position for smooth working of the SRL or fall arrestor. The sunk profile (4) holds the wire brush (5) and carries out the wire brush (5) once the wire brush (5) needs to be replaced or checked. If the sunk profile (4) is not present then, two guides (1, 2) do not match properly with each other and number of wire brush (5) will be limited. It is to be noted that, the sunk profile (4) provides a cavity for wire brushes to be fit inside or between the outer guide (1) and inner guide (2).

Once the wire brush (5) is placed, both the guides (1, 2) are screwed or riveted or fastened together with help of dowels by matching the holes (3) formed over inner guide (2) in line with the holes (3) formed on the outer guide (1). It is to be noted that, a user manually needs to position the inner guide (2) in order to align the holes (3) formed over the inner guide (2) in line with holes (3) formed over the outer guide (1). The outer guide (1) and the inner guide (2) have inner cavity profile to allow the lifeline or wire or cable used in the SRLs or fall arrestors to pass through it without any friction. If user wants to replace the wire brush (5) then the user manually needs to remove screws or rivets and further removes the inner guide (2) from the outer guide (1). Further the user manually needs to remove used or old wire brush (5) and replace with the new one wire brush (5). The bristles of the wire brush (5) encircles the cable or rope of the SRL or fall arrestor and the bristles are designed to remove the dirt or dust present over the cable or rope. Once the wire brush (5) is placed in the cavity, both the guides (1, 2) are screwed or riveted or fastened together with help of dowels by matching the holes (3) formed over the inner guide (2) in line with the holes (3) formed on the outer guide (1) to complete the procedure of replacing the wire brush (5).

The present invention exhibits following advantages:
(a) The present invention provides a cost-effective, a compact and easy to use wire brush assembly for Self Retracting Lifelines or fall arrestors.
(b) The present invention provides an easy method of replacing wire brush in short time from the SRLs or fall arrestors.

While this invention has been described in connection with what is presently considered to be the most practical and preferred embodiment, it is to be understood that the invention is not limited to the disclosed embodiments, but, on the contrary, is intended to cover various modifications and equivalent arrangements included within the scope of the appended claims.

1. A wire brush assembly, comprising:
a) an outer guide coupled with a housing of a Self Retracting Lifeline (SRL); and
b) an inner guide detachably inserted within the outer guide; wherein,
i. a plurality of matching holes formed over the periphery of the outer guide and the inner guide;
ii. the inner guide structured in a way such that the inner guide (2) able to insert/extract from the outer guide;
iii. the inner guide have a sunk profile with a collar on its periphery to accommodate one or more wire brush and firmly hold the wire brush between the outer guide and inner guide; and
iv. the inner guide and outer guide are secured together by attachment means which connects the guides via the matching holes after insertion or removal of the wire brush in a cavity formed by the sunk profile.

2. The assembly as claimed in claim 1, wherein the outer guide is having a round or A/F outer profile and a circular inner profile.

3. The assembly as claimed in claim 1, wherein the inner guide and outer guide is made of materials selected from a group of steel, aluminum, polymers or any other combination thereof.

4. The assembly as claimed in claim 1, wherein the attachment means are selected from rivets, screws, and threaded profiles.

5. A method for replacing wire brush from self retracting lifeline, comprising steps:
i. extracting attachment means from a plurality of matching holes
ii. removing an inner guide from an outer guide;
iii. inserting a wire brush into a cavity formed by a sunk profile in between the inner and outer guide; and
iv. attaching the inner guide within the outer guide by aligning the holes and securing the guides together via the attachment means.
